(19) United States
(12) Patent Application Publication
(10) Pub. No.: US 2025/0210336 A1
(43) Pub. Date: Jun. 26, 2025

(54) MASS SPECTROMETER AND METHOD OF CALIBRATING A MASS SPECTROMETER

(71) Applicant: Thermo Fisher Scientific (Bremen) GmbH, Bremen (DE)

(72) Inventor: Norbert QUAAS, Bremen (DE)

(73) Assignee: Thermo Fisher Scientific (Bremen) GmbH, Bremen (DE)

(21) Appl. No.: 18/991,197

(22) Filed: Dec. 20, 2024

(30) Foreign Application Priority Data
Dec. 21, 2023 (GB) 2319756.9

(51) Int. Cl. H01J 49/02; H01J 49/00

(52) U.S. Cl. CPC H01J 49/025; H01J 49/0036

(57) ABSTRACT

Methods of checking calibration of a dual-mode secondary electron multiplier (SEM) detector of a mass spectrometer using non-analyte ions comprise: recording, using a counting mode detector of the dual-mode SEM detector, a first count signal related to the number of non-analyte ions incident at the SEM detector at a working point voltage; offsetting the working point of the counting mode detector and recording second count signals related to the number of non-analyte ions incident at the SEM detector at respective two or more offset working point voltages; fitting a non-linear function to the first and second recorded count signals and values corresponding to the working point voltages; and determining that the calibration is valid if a rate of change of the non-linear function at the calibrated working point is within an acceptance range. A mass spectrometer configured to perform the method is also described.

### CROSS REFERENCE TO RELATED APPLICATIONS

This application claims priority from GB 2319756.9, filed Dec. 21, 2023, which is incorporated herein by reference.

### TECHNICAL FIELD

The present invention relates to secondary electron multiplier (SEM) detectors, such as are used for detecting ions emerging from a mass analyser of a mass spectrometer. In particular, the present invention is directed to calibration of such detectors and checking existing calibration of the detectors.

### BACKGROUND

Mass spectrometry is a range of techniques for identification and quantification of species in a material. Elemental mass spectrometry is one branch of mass spectrometry in which it is desired to determine the type and quantity of chemical elements present in a sample. For accurate measurements a wide dynamic range is required, or at least beneficial.

A secondary electron multiplier (SEM) detector is a type of detector which has surfaces coated with a secondary-emissive material. When an electron strikes the secondary-emissive material, secondary electrons are emitted. If multiple such structures are cascaded one after the other, then the generation of secondary electrons is repeated and the number of electrons can be increased many times such as by a factor of a million. Such a detector may be known as an electron multiplier detector. One type of mass spectrometry that uses such detectors is inductively coupled mass spectrometry (ICP-MS). To achieve a wide dynamic range, SEM detectors may be dual-mode detectors, having two modes of operation, namely a counting or pulse mode, and an analogue mode. The counting mode may provide a dynamic range of 106 and the analogue mode may provide an additional 3 to 4 orders of magnitude dynamic range. Usually the two modes of operation have some range of overlap to allow one mode to be calibrated against the other. Some systems have an additional electrometer mode that provides a further 3 to 4 orders of magnitude dynamic range, which is achieved by measuring the ion beam directly using a Faraday cup.

More detail of the structure of a dual mode SEM ion detector is shown schematically in FIG. 1. The ion detection device comprises a series of dynodes, shown as D1-D8 and a detector T1. An ion beam I incident at the first dynode D1 is converted into one or more electrons. This first dynode is sometimes known as a conversion dynode because it converts incoming ions into electrons. The dynodes are under a suitable electric potential which is negative and is increasing (becoming closer to ground) as you move from the first dynode D1 to the last dynode D8. Although the Figure shows eight dynodes, other numbers of dynodes may be used. The one or more electrons generated by the first/conversion dynode are accelerated by the electric potential towards the next dynode. At each subsequent dynode the impact of an electron at the dynode generates one or more secondary electrodes and are again attracted to the next dynode. This results in a cascade of increasing numbers of electrons. For example, for a single electron arriving at D1, a million electrons might be incident at the detector T1. The detector T1 may collect the electrons and convert them to a voltage or current that forms an output signal. For the detector T1 following the last dynode the output signal is known as the pulse or count signal, S_{c}. The amplification provided by the series of dynodes is large. If the number of ions entering the detection device is relatively high, the number of electrons arriving at the detector T1 may be greater than the maximum detectable signal that can be accommodated by the dynamic range of the detector. As shown in FIG. 1, a second output signal known as the analogue signal, SA, may be output from part way along the series of dynodes. For example, in FIG. 1 the analogue signal is derived from the fifth of the eight dynodes. In general, a dynode providing the analogue signal will be part way along the series of dynodes, for example, at a dynode in the middle of the series. Since at the fifth dynode the amplification of the number of electrons is not as large as at the eighth dynode, for larger numbers of input ions the analogue signal will continue to provide an output signal thereby increasing the dynamic range over that for the pulse/counting signal alone.

For inductively coupled plasma mass spectrometry (ICP-MS), for example, the detection device should be able to operate over nine orders of magnitude of dynamic range and preferably more. This is so that the detection device is able to detect the major and minor components of a sample.

As mentioned in the preceding paragraphs, the two detection modes can be calibrated against each other in ranges where both detectors operate. Once calibrated the system should deliver reliable quantitative outputs for days, weeks or even months depending on the intensity of use. However, a problem with dual-mode SEM detectors is drift of their amplification factors due to the aging effects of the dynode surface material.

U.S. Pat. Nos. 5,463,219 and 11,469,091 B1 describe dual-mode secondary electron multiplier detectors used in mass spectrometers. GB 2421841 A describes a method of cross-calibrating between a counting mode detector and an analogue mode detector of a secondary electron multiplier.

### SUMMARY OF THE INVENTION

The present invention provides a fast method of checking whether an existing calibration of a counting mode detector remains accurate. Methods also provide fast methods for checking cross-calibration between the counting mode detector and an analogue mode detector, and methods of recalibration. These methods may be performed by a mass spectrometer instrument in the background or in idle times, without requiring user input. The methods may use argon ions, derived from argon as a carrier gas which is used for generating and flowing sample ions through the spectrometer. Argon may be flowed through the spectrometer when no sample is present and so the calibration checks and calibration may be performed without requiring a calibration sample or solution. Argon and/or other non-analyte gases may be used.

The present invention provides a method of checking calibration of a dual-mode secondary electron multiplier (SEM) detector of a mass spectrometer using non-analyte ions, the method comprising: setting a counting mode detector of the SEM detector to a calibrated working point by providing a working point supply voltage to the counting mode detector; recording, using the counting mode detector, a first count signal based on the number or quantity of non-analyte ions incident at the SEM detector; offsetting the working point of the counting mode detector by adjusting the supply voltage to the counting mode detector; recording, using the counting mode detector, second count signals at respective one, two or more offset supply voltages related to the number or quantity of non-analyte ions incident at the SEM detector; fitting a non-linear curve or function to the first and second recorded count signals and values corresponding to the counting mode detector supply voltages; and determining that the calibration is valid if a rate of change of the non-linear curve at the calibrated working point is within an acceptance range. By the term “non-analyte ions” we mean ions that are not analytes, that is, they are not part of a sample being analysed. The non-analyte ions may include ions used for flowing the sample through the analyser, such as carrier gas ions or carrier ions. The non-analyte ions may include argon ions, which argon ions may originate from a carrier gas and/or a plasma gas. The non-analyte ions may additionally, or alternatively, include calibrant ions produced from a calibration solution. The term “non-analyte ions” includes majority ions. Typically, majority ions include carrier gas ions but do not include calibrant ions.

The count signals mentioned herein may relate to a number of counts detected by the counting mode detector in a period of time such as one second, or averaged over such a period of time. The counts may be actual counts of incident electrons, detection of charged particles or an accumulation of voltage. The use of curve-fitting allows rapid determination of whether the working point has moved and requires adjustment, as well as indicating the amount and direction of adjustment that may be needed. In particular, curve-fitting typically allows the amount and direction of adjustment to be determined without requiring additional offset working point voltages.

The offsetting the working point of the counting mode detector by adjusting the supply voltage may comprise offsetting the working point to a first offset working point at a voltage higher than the working point voltage and offsetting the working point to a second offset working point at a voltage lower than the working point voltage; and wherein recording the second count signals at the respective two or more offset working point voltages comprises recording an upper second count signal at the first offset working point voltage and recording a lower second count signal at a second offset working point voltage. Alternatively, second count signals may be measured at one offset working point or more than to offset working points. In embodiments, the offset working points may all be at higher or at lower voltages compared to the working point voltage. By working point voltage we mean the voltage at which the detector is operating for analysis, such as determined through an earlier calibration or previously set by other means.

The acceptance range may be an acceptance range normalized with respect to the count signal at the calibrated working point.

The normalised acceptance range may be a less than 5%, 10% or 15% rate of change in the non-linear curve at the calibrated working point.

The non-linear curve may be a second order polynomial.

The method may further comprise, based on determining that the rate of change of the non-linear curve at the calibrated working point is not within the acceptance range, estimating based on the non-linear curve or function the supply voltage at which the rate of change of the non-linear curve will be within the acceptance range, and adjusting the working point to the estimated supply voltage.

The method may further comprise recording an updated first count signal at the counting mode detector with the working point changed to the estimated supply voltage, re-fitting a non-linear curve or function to data comprising the first count signal, second count signals and the updated first count signal at the estimated supply voltage, and determining if the rate of change of the non-linear curve or function at the estimated supply voltage is within the acceptance range.

The step of estimating based on the non-linear curve or function the supply voltage at which the count signal will be within the acceptance range may comprise estimating the supply voltage at which the rate of change of the non-linear curve or function is at a target value in the acceptance range. The target value may be a mid-point of the acceptance range.

The method may further comprise, based on determining that the rate of change of the non-linear curve or function at the calibrated working point is not with the acceptance range, providing an alert to the user requesting the user perform a recalibration of the counting mode detector.

The method may comprise, when it is determined that the calibration is not valid, performing a recalibration of the counting mode detector.

The recalibration of the counting mode detector may comprise: offsetting the working point of the counting mode detector by adjusting the supply voltage to the counting mode detector to one or more second offset voltages; recording, using the counting mode detector, third count signals at the respective one or more second offset working point voltages based on the number or quantity of non-analyte ions incident at the SEM detector; fitting a second non-linear curve or function to the first, second and third recorded count signals and values corresponding to the counting mode detector supply voltages; and estimating based on the second non-linear curve or function the supply voltage at which the rate of change of the second non-linear curve or function will be within a second acceptance range, and adjusting the working point to the estimated supply voltage.

The second non-linear curve may be a third order polynomial.

The second acceptance range may be a less than 5%, 10% or 15% rate of change in the non-linear curve at the working point.

The method may further comprise recording an analogue signal at an analogue mode detector of the dual-mode secondary ion detector; calculating a cross-calibration factor between the analogue mode detector and the counting mode detector based on the first count signal and an analogue signal at working points of the counting mode detector and analogue mode detector; and determining that the cross-calibration is valid if the cross-calibration factor is within a window or a target calibration factor.

The method may comprise performing a correction of the measured cross-calibration between the counting mode detector to an analogue mode detector if it is determined that the cross-calibration is not valid.

The cross-calibration correction may comprise: recording, using the analogue mode detector at the analogue mode detector working point supply voltage, a first analogue mode signal related to the number or quantity of non-analyte ions incident at the SEM detector; recording, using the counting mode detector at the counting mode detector working point supply voltage, a first cross-calibration counting mode signal the number or quantity of non-analyte ions incident at the SEM detector; offsetting the working point of the analogue mode detector and the counting mode detector by adjusting the supply voltages to the analogue mode detector and the counting mode detector; recording, using the analogue mode detector and counting mode detector, a second analogue mode signal and a second cross-calibration counting mode signal, at the adjusted supply voltages, related to the number or quantity of non-analyte ions incident at the SEM detector; repeating the step of offsetting and recording a further second analogue mode signal and a further second cross-calibration counting mode signal; determining cross-calibration factors for the first, second and further second analogue mode signals and counting mode signals; fitting a third non-linear curve or function to the first, second and further second analogue mode signals and values corresponding to the working point voltages of the analogue mode detector; estimating based on the third non-linear curve or function the analogue detector supply voltage at which the cross-calibration factor is in an acceptance range or meets a target; based on the estimated analogue detector supply voltage at which the cross-calibration factor is in an acceptance range or meets a target, estimating a counting mode detector supply voltage for the acceptance range or target; and adjusting the working point voltages of the analogue mode detector and counting mode detector to the estimated supply voltages.

The non-analyte ions may be argon ions, noble gas ions or nitrogen ions.

The methods described herein may be performed without a calibration solution, using non-analyte ions.

The method may be performed prior to running an analysis on a sample and/or in the background without alerting a user.

The method may be performed at regular intervals in the background without alerting a user.

A method of checking cross-calibration of a dual-mode secondary electron multiplier (SEM) detector of a mass spectrometer using non-analyte ions, the method comprising: setting a counting mode detector of the dual-mode SEM detector to a calibrated working point by providing a working point supply voltage to the counting mode detector; setting an analogue mode detector of the dual-mode SEM detector to a calibrated working point by providing a working point supply voltage to the analogue mode detector; recording, using the counting mode detector, a count signal related to the number of non-analyte ions incident at the SEM detector; recording, using the analogue mode detector, an analogue mode signal related to the number of non-analyte ions incident at the SEM detector; calculating a cross-calibration factor between the analogue mode detector and the counting mode detector based on the count signal and the analogue mode signal; and checking if the cross-calibration factor is within a window or a target calibration factor.

The present invention provides a method of checking calibration of a dual-mode secondary electron multiplier (SEM) detector of a mass spectrometer, the method comprising: obtaining a first count signal from a counting mode detector at a working point voltage, the first count signal related to the number or quantity of non-analyte ions incident at the SEM detector; obtaining second count signals related to the non-analyte ions at one, two or more offset working point voltages of the counting mode detector; fitting a non-linear curve or function to the first and second count signals and values corresponding to counting mode detector supply voltages; and determining that the calibration is valid if a rate of change of the non-linear curve at the calibrated working point is within an acceptance range.

A computer-readable medium storing instructions, which when executed by a processor, causes the processor to carry out the preceding method.

A mass spectrometer comprising a dual-mode secondary electron multiplier (SEM) detector configured to perform any of the method set out herein.

### BRIEF DESCRIPTION OF THE DRAWINGS

Embodiments of the present invention, and aspects of the prior art, will now be described with reference to the accompanying drawings, of which:

FIG. 1 is a schematic diagram of a dual-mode SEM type detector;

FIG. 2 is a schematic graph of detector supply voltage against normalised count rate for the counting mode detector;

FIG. 3 is a graph of total detector supply voltage against normalised count rate for the counting detector, showing changes in working point due to aging of the detectors;

FIG. 4 is a graph of total detector supply voltage against normalised count rate for the counting detector, showing a plateau criterion for a given working point;

FIG. 5 is a flow diagram of a method according to an embodiment of the present invention of checking the working point of the counting detector using the plateau criterion;

FIG. 6 is graph showing measurements from a counting mode detector against counting mode detector supply voltage for checking the working point meets the plateau criterion;

FIG. 7 is a flow chart of a method of performing a cross-calibration check between the counting mode detector and the analogue mode detector;

FIG. 8 is an example graph showing cross-calibration between the analogue detector and counting mode detector across a range of atomic mass units. The data encircled in black result from the non-analyte ions 36Ar and 38Ar;

FIG. 9 is a flow chart of a method of checking and, if required, recalibrating a counting mode detector and analogue mode detector;

FIG. 9A is a flow chart of a method of recalibrating a counting mode detector and analogue mode detector, according to an embodiment of the invention;

FIG. 10 is a flow chart of a method of adjusting the cross-calibration between the counting mode detector and the analogue detector;

FIG. 11 comprises a table and graph of data of an example of the cross-calibration adjustment method of FIG. 10;

FIG. 12 is a flow chart of a method of adjusting the working point voltages, or gain curve, of the counting mode detector;

FIG. 13 comprises a table and graph of data of an example of adjusting the working point voltages, or gain curve, of the counting mode detector according to the method of FIG. 12; and

FIG. 14 is a flow chart of a method of checking and calibrating an analyser including a user prompted calibration with a calibration solution.

### DETAILED DESCRIPTION

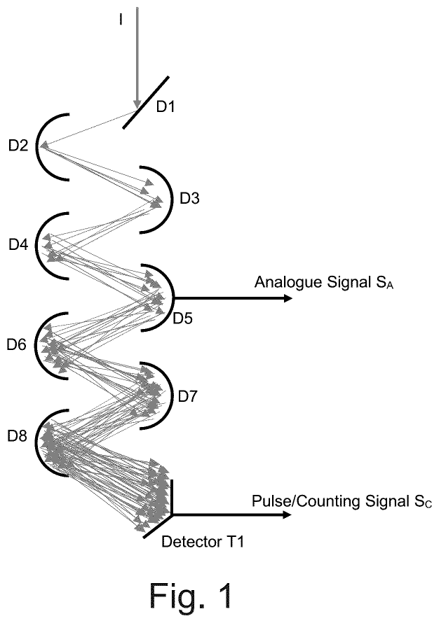

As previously described, FIG. 1 is a schematic diagram of a dual-mode detector, which may for example, comprise a plurality of dynodes. The voltage on the first/conversion dynode will be negative and relatively high. The voltages on the following dynodes will be increasing such that they remain negative but with decreasing magnitude. Voltages on later dynodes in the series may be positive and become increasingly positive towards the end of the series of dynodes. The voltage difference between consecutive dynodes may be the same. In some embodiments, the voltage difference between the first two dynodes may be higher than between the other dynodes. In some embodiments the voltage difference may sequentially increase for the later dynodes. The following table provides example voltages for a dual-mode detection device having eight dynodes as in FIG. 1. The table also includes the voltage at the detector T1 which is positive. Hence, the detector T1 is sometimes considered to be the anode of the detection device. The values given in the following table are example voltages such as for a positive-ion dual-mode detector without a separate conversion dynode. The ions will be converted on the first detector dynode to secondary electrons at a potential of −Ua. For negative ion detection or the use of a separate conversion dynode, voltages at the dynodes and resulting potential landscapes are different. However, the check and calibration methods described here can also be applied in similar form.

| Dynode Number | Voltage applied / V | |
|---|---|---|
| D1 | −2000 | V |
| D2 | −−1200 | V |
| D3 | −800 | V |
| D4 | −400 | V |
| D5 | 0 | V |
| D6 | +400 | V |
| D7 | +800 | V |
| D8 | +1200 | V |
| Detector T1 | +1600 | V |

Increasing the magnitudes of the voltages on the dynodes and the detector T1 will tend to increase the amplification of the number of electrons such that the gain at the analogue and pulse counting signals is increased. However, the dynodes may be more likely to age more rapidly when held at voltages of higher magnitude. This may be because of aging effects on the surface material of the dynode.

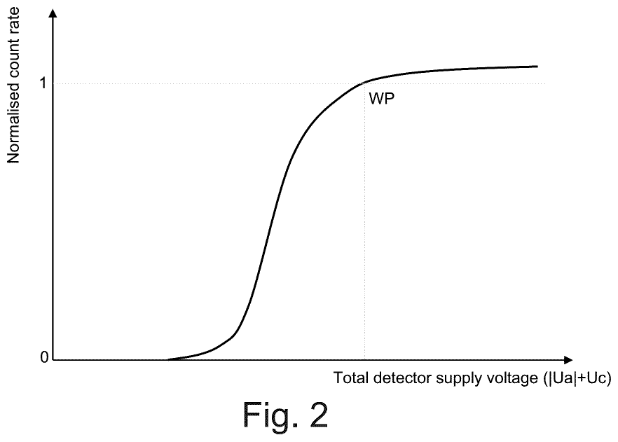

FIG. 2 is a schematic graph of detector supply voltage against normalised count rate. The abscissa represents the total detector supply voltage. That is, the sum of the magnitudes of the voltages at the analogue detector and the pulse counting or counting mode detector. For the more usual positive ion detection, the voltages at the entrance to the detector are negative to attract the positive ions into the detector. Hence, the voltage at the analogue detector is usually negative. The electrons continue to be amplified towards the counting detector. The counting detector has a positive voltage. The sum of the voltage from the analogue detector to the counting detector may be written as:

|−Ua|+Uc

where Uc is the voltage at the counting detector and Ua is the voltage at the analogue detector. Since Ua is usually negative, to obtain the sum it is written here taking its magnitude. The sum value is a measure of how strongly electrons are accelerated from the analogue detector to the counting detector dynode surface and hence is a measure of the amount of secondary electrons that are likely to be generated. Returning to FIG. 2, the ordinate is a measure of the count rate for the pulse/counting detector at the respective detector voltages after normalisation against the count rate for the pulse/counting detector at the working point voltages for the analogue and counting detectors. By definition, in the schematic curve the count rate at the working point, WP, voltages is unity. At lower voltages the count rate reduces at increasing rates, whereas at higher voltages the count rate increases but only very slowly. This is due to the fact that at a well-calibrated WP, there are only very few electron pulses left that stay beyond the detection threshold of the detection system. A well-calibrated WP is characterized by detection of >90% of all the electron pulses that were created by the ions being incident onto the detector.

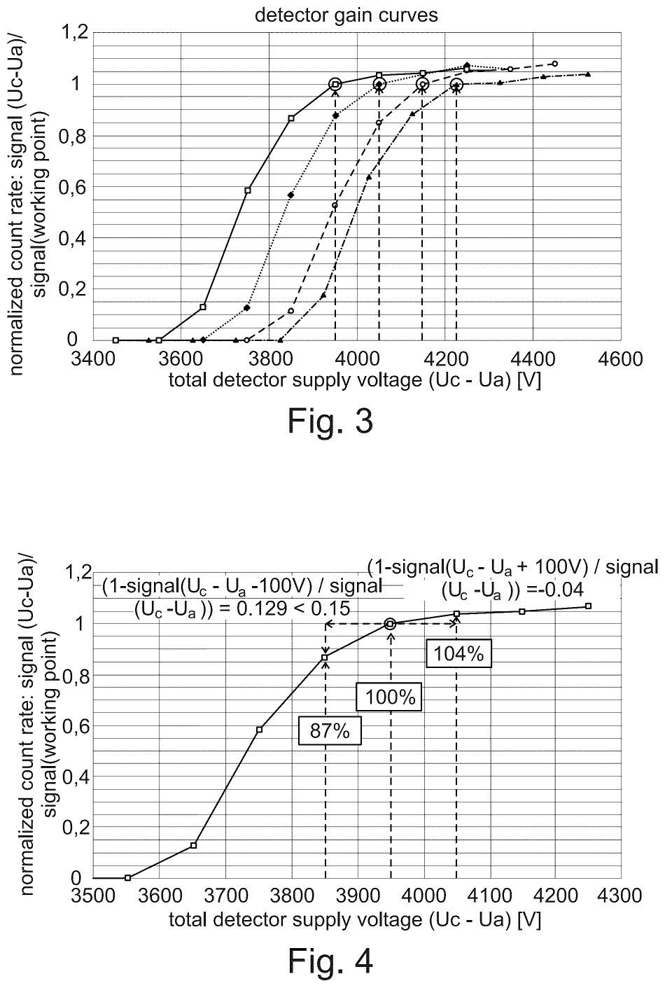

We have previously stated that aging of the dynodes can cause the amplification factors to change. FIG. 3 shows how aging of a dual mode SEM detection device results in the gain curve shifting and results in a shift in working point. The shape of the gain curve remains substantially the same as the detector ages, but the working point and specific gains requiring increasing voltage. Similarly to FIG. 2, the abscissa of FIG. 3 shows total detector voltage, |−Ua|+Uc (written in the Figure as Uc−Ua) applied to the dynodes at which the detectors are connected, where Uc is the voltage at the counting dynode and −Ua is the voltage at the analogue detector. The ordinate shows the normalised count rate, that is, the count rate (as measured at the pulse/counting detector T1) at a range of total voltage, normalised against the signal at the working point when Uc−Ua is at the working point. FIG. 3 shows four measured gain curves. The measured data points for each of the different curves respectively are represented as squares, diamonds, circles and triangles. The curve having data points represented as squares is for the least amount of aging and has the lowest total voltage. For this curve the working point is at around 3950V. The curves having datapoints represented by diamonds, circles and triangles are for respectively longer and longer aging. The working points respectively are around 4050V, 4150V and 4210V.

To determine the working point, the total detector supply voltages are varied and a corresponding change in counts at the counting detector is analysed. For a dual-mode detector which respectively has supply voltages Ua for the analogue detector and Uc for the counting detector, the working point is defined by a plateau criterion. This criterion checks for the slope of the gain curve at the working point. Ideally the working point would be at a total voltage at which the gain is a maximum. However, as shown schematically in FIG. 2 and can also be seen in FIG. 3, although the gain becomes almost flat at higher supply voltages, it continues to rise a small amount. Hence, a simple algorithm to maximise the gain may result in pushing the detector supply voltages to high levels resulting in aging of the detectors. Hence, it is preferable that the working point voltages are set to a point where steep increases in gain have slowed for increasing supply voltages.

The plateau criterion is used to check the gain slope at the working point is towards the plateau of the curve approaching a maximum gain. The criterion is characterized by checking that working point is approaching the maximum by requiring that a signal loss if the detector supply voltages are reduced is within an acceptance range. In other words, the plateau criterion checks that the working point is set close to the plateau. If the working point is away from the plateau and down the steeper part of the slope of reducing signal, then a given change in supply voltage away from the working point will result in a large drop in signal. Since detector types and signals vary, the signal variation is normalised against the signal at the working point. As set out above, the working point voltages for the counting and analogue detectors may be Uc and −Ua respectively. The change in working point voltage is given by ΔU. The plateau criterion may be defined by the following equation:

$$\vert 1 - \frac{signal ( {U}_{c} - {U}_{a} - Δ U )}{signal ( {U}_{c} - {U}_{a} )} \vert < Acceptance range \qquad Equation 1$$

FIG. 4 shows the variation in signal for a range of working points. The nominal working point voltage (Uc+|−Ua|) is set at around 3950 V which is identified in the Figure as the signal being 100%. For a change in working point voltage supplied to the detectors of +/−100V, that is to 3850 V and 4050 V, the variation in signal count is determined. For the −100V change in supply voltage the signal falls to 87% of that at the nominal working point. This is written as a change of 0.129 according to the above equation and meets the criterion of being less than 0.15. For a +100V change in supply voltage the value of the above equation is −0.04 which also meets the criterion of being less than 0.15. This is shown on the graph as the normalized signal increasing to 104% of that at the working point. Hence, at a working point voltage of 3950 V the detector is working meeting the plateau criterion. At the criterion the response flattens significantly such that the count rate hardly increases above 105% in the context of the graph as a whole, even at 4250 V supply voltage. Hence, more than 90% of the pulses are detected when the voltages are set to the WP values.

Alternatively, since much of the variation in signal is dependent on the working point of the counting detector, when checking and adjusting the counting detector working point, we may vary only Uc and keep Ua fixed. Hence, the plateau criterion may be written based solely in relation to the variation in signal with supply voltage to the counting detector. If Pc(Uc) is an equation defining the signal as a function of the supply voltage to the counting detector, the plateau criterion may be written as:

$$\vert \frac{{Pc}^{′} ( Uc 0 )}{Pc ( Uc 0 )} \vert < Acceptance range \qquad Equation 2$$

where Pc′(Uc0) is the gradient of the function at the working point voltage and Pc(Uc0) is the value of the function at the working point voltage.

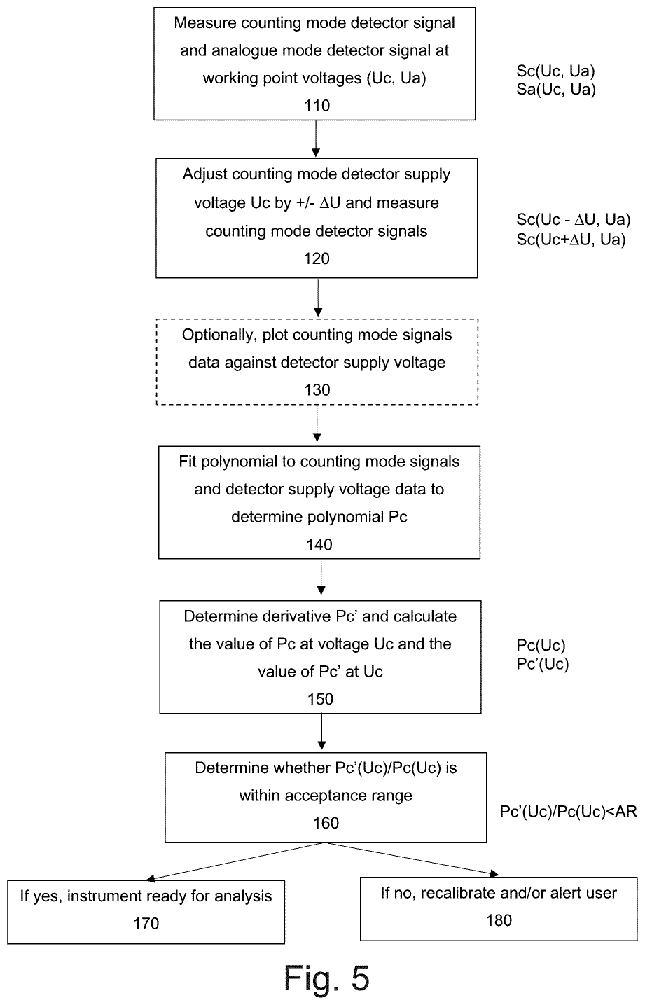

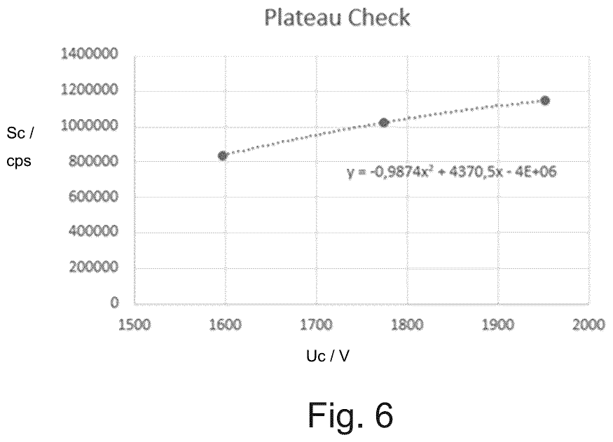

FIG. 5 is a flow diagram showing a method according to an embodiment of the present invention of using the plateau criterion to check the working point of the counting detector. The method comprises setting the counting mode detector and analogue mode detector at their working point voltages and at step 110 measuring the signal Sc at the counting mode detector and measuring the signal Sa at the analogue mode detector. Although the signal Sa at the analogue mode detector is not required for the plateau check, it is useful to measure at this point because it may be required later for a cross-calibration check between the two detectors. At step 120 the supply voltage to the counting mode detector is adjusted by +/−ΔU and the respective counting mode signals, Sc(Uc+ΔU, Ua) and Sc(Uc−ΔU, Ua), are measured. At step 130 the counting mode signals may be plotted on a graph against the counting detector supply voltage. This is optional for visualisation but is not necessary. FIG. 6 is an example plot of this data. Against the horizontal axis is plotted the supply voltage, Uc, of the counting mode detector in volts. Against the vertical axis is plotted the signal, Sc, at the counting mode detector, in number of counts per second (cps). Alternatively, the signal and detector voltages can be plotted as percentages and/or relative to the working point. The three data points plotted are at the working point and offset from the working point by +/−ΔU. In this case the working point is 1775 V and the offset points are offset by +/−10%, that is to 1597.5 V and 1952.5 V. The measured signal values for the three points are listed in Table 1 which follows.

TABLE 1

| | Uc | Uc − 10% | Uc + 10% |
|---|---|---|---|
| Uc [V] | 1775 | 1597.5 | 1952.5 |
| Signal [cps] | 1021190 | 836481 | 1143682 |
| DeltaSignal [cps/V] | 865 | 1216 | 515 |
| DeltaSignal / Signal | 0.00084 | 0.00145 | 0.00045 |
| [1/V] | | | |

At step 140, a curve Pc is fitted to the three data points. The equation for the curve for the example data is shown in the graph of FIG. 6. The curve is preferably a second order polynomial since such an equation is the lowest order function for precisely describing three data points. However, other functions such as an exponential or Fermi curve may be used. The curve or function may be determined directly by solution or by regression. Using the equation of the curve, at step 150, the derivative Pc′ of the equation is determined such that that the gradient can be calculated at any given supply voltage, such as for Uc−10% and Uc+10%. In Table 1 the values of the gradient at the respective points is indicated by the row labelled “DeltaSignal”. The row “DeltaSignal/Signal” is the gradient divided by the signal at that voltage supply setting. Hence, the values in the row “DeltaSignal/Signal” correspond to the term |Pc′(Uc0)/Pc(Uc0)| in equation 2 discussed previously. Determining the value of this term and checking against the acceptance range for the plateau condition is shown as step 160 in FIG. 5. At step 170, if the calculated value of the term is within the acceptance range, the working point of the counting mode detector meets the plateau criterion and the instrument is ready for performing analysis. At step 180, if the calculated value of the term is outside of the acceptance range, the working point of the counting mode detector does not meet the plateau criterion and the instrument may need to be recalibrated. In such a case, it may be necessary to alert the user or automatically start a recalibration process. The plateau check takes around 15 seconds as compared to around 10 minutes for a full calibration according to the prior art. Hence, the plateau check is much quicker reducing downtime of the instrument.

In the data of FIG. 6 and Table 1 the acceptance range for equation 2 is a change of 0.08-0.1% of the signal per volt at the working point voltage, which gives the range 0.0008 to 0.001. Based on Table 1 the value is 0.00084 and so is within this range. In embodiments the values at the offset working points may also be taken into consideration.

The calibration check is preferably performed in the background using non-analyte ions such as argon ions. In this way the check can be performed regularly and often to confirm the calibrations are valid.

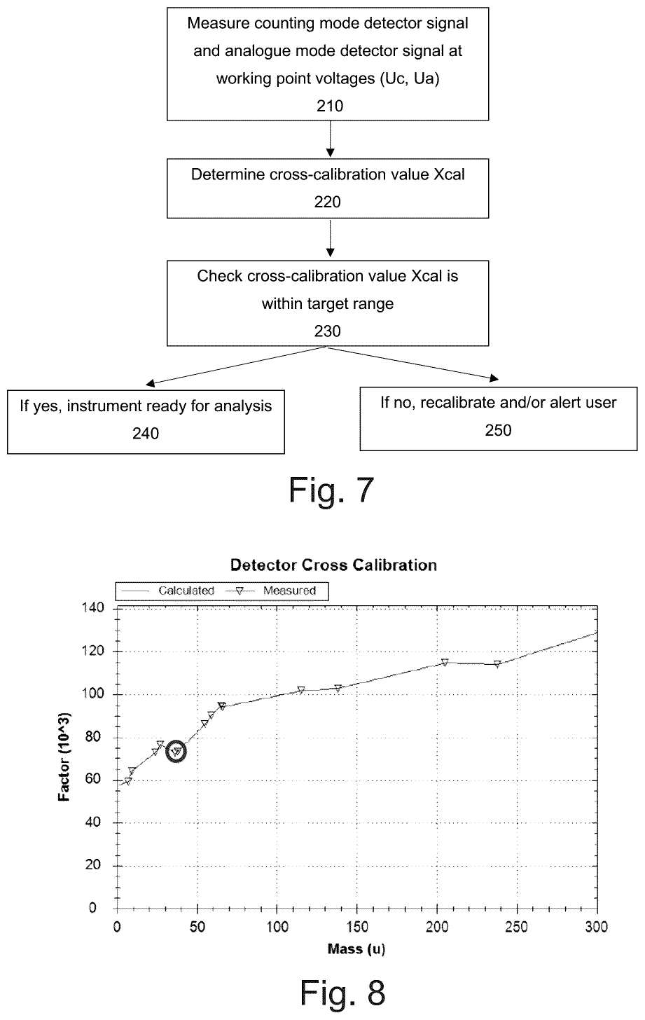

FIG. 7 is a flow chart showing a method of performing a cross-calibration check. This method is used to check that the cross-calibration factor between the counting mode detector and the analogue mode detector remains accurate. As described earlier the counting detector is used to measure low levels of ions and may have a dynamic range of 106. The analogue mode detector may provide an additional 3 to 5 orders of magnitude dynamic range. There is a measurement region where both detectors are capable of operating and the cross-calibration factor is used to scale the measurements on one detector to those on the other. The cross-calibration factor is determined periodically but preferably needs to be checked frequently because of aging of the detectors. If a recalibration of one of the detectors is performed, then the cross-calibration factor will likely need to be updated.

In FIG. 7 the first step 210 of the cross-calibration method is to measure the signals at the counting detector and the analogue detector at the working point voltages Ua and Uc. If the plateau check has already been performed these signal values will already have been measured. At step 220 the cross-calibration factor between the two signals is determined. This is simply determined as the ratio of the two values. Some checking of the signal quality may also be performed such as by checking that the signal levels fall within the window in which the two detectors are both detecting effectively. For example, the analogue signal may be checked that it exceeds a first minimum threshold and the counting signal may be checked that it exceeds a second minimum threshold. The second minimum threshold will be higher than the first. Variation in the signals may also be checked to avoid large fluctuations in the signals. The variation may be checked by calculating a relative standard deviation (RSD) and checking it is less than, for example, 5% or 10%. If the signals do not exceed the thresholds or there is too great a variation, a change will be required to the analyte levels or non-analyte ion levels, for example, to increase the signal levels. At step 230 the calculated cross-calibration factor is checked against a target range. If the cross-calibration factor is within the target range, at step 240, the instrument is ready for analysis. If the cross-calibration factor is outside of the target range, at step 250, a recalibration may be required and/or the user may need to be alerted. The target cross-calibration factor may be a default target value based on the design of the instrument. If non-analyte ions are used, as is the case here, the target value may be different and the target value will be measured and saved separately for comparison. The range may be a 5% or 2% window around that target.

The plateau check and cross-calibration check require only a small number of data points which can be recorded quickly by varying the supply voltages to the detectors. This may be performed when a calibration solution is the analyte in the instrument. Alternatively, and preferably, the instrument may be operated without a calibration solution. In normal analyte measuring operation for an ICP source a plasma is generated in a flow of argon gas with the sample introduced through a nebulizer to the plasma. Without an analyte present the plasma may still be generated. Argon ions are passed to the dual-mode detector. The conversion dynode of the dual-mode detector may convert the ions to electrons for amplification in the subsequent dynode stages.

The plateau check and cross-calibration check can be applied when an analyte is present or when no analyte is present by detecting the argon ions. The checks are fast and since no analyte or calibration solution is needed the checks can be performed in the background unnoticed by the user. For example, the checks may be performed when the instrument is first turned on and ready for use, or periodically between measurement of samples. This allows the measurement time when an analyte is present to be maximised. Alternatively, the checks may be performed when the instrument is analysing a sample but for the plateau check the need to offset the counting mode detector supply voltages will take up a small amount of the analysis time. On the other hand the cross-calibration check does not require such changes in voltage and may readily be performed at any point during an analysis of a sample or when the instrument is on standby with argon ions only. Hence, although we have described performing the plateau check and cross-calibration check together they may be performed at separate times or on different schedules. However, as we will describe below the cross-calibration factor varies with mass unit so the regular use of non-analyte argon ions provides a reproducible check that the cross-calibration remains valid.

As discussed, argon is present in ICP-MS instruments because it is used in the creation and stabilisation of the plasma and also for carrying the sample to the plasma. Hence, an ICP-MS will always include abundances of argon ions. Argon may be present in a number of forms such as ³⁶Ar and ³⁸Ar argon ions, and argon ⁴⁰Ar-⁴⁰Ar dimers. Conventionally, the presence of ³⁶Ar and ³⁸Ar ions and ⁴⁰Ar-⁴⁰Ar dimers means that it is not possible to reliably measure the quantities of other ions at these masses, namely 36, 38 and 80 amu.

The present invention proposes using the argon ion abundances for working point calibration of the detectors such as when the instrument is not taking measurements. For example, the instrument may be flowed with argon gas to produce argon ions. The argon ions are converted to electrons which are then detected by the two detectors of the dual-mode detector. The ICP source will always provide different abundances of argon ions, depending on its analytical temperature and the conditions in the interface that transfers
³⁶Ar: 0.334%
³⁸Ar: 0.063%
⁴⁰Ar: 99.6%
   Mass analysers and detection devices will generally be able to measure and distinguish between these species. For example, an instrument having a typical 115 In base sensitivity of approximately 400 kcps per ppb will show ³⁸Ar ion sensitivities of between 1.0 Mcps and 10 Mcps, depending on the interface settings between the plasma torch and analyser. These count rates are readily measured by the counting mode detector. If the instrument is less sensitive than this, the ³⁶Ar ions can be measured instead, which are a factor of around fives times more abundant. Moreover, ⁴⁰Ar is always present as the ⁴⁰Ar-⁴⁰Ar dimer and can be used instead. Mass separation may be used and any one or more of the argon isotope ions may be detected. If some or all of these signals are out of convenient range, they can be brought to a usable level by shifting extraction lens voltages or ion source conditions such as sampling depth for the time of the check/recalibration.

Although the use of argon ions is preferred for the checks and calibrations described herein, other ions may be used. All ions that are present in suitable, stable abundances such as between 1-5 Mcps may be used. The ions could be from gas additions to the source gas such as helium, neon or nitrogen. However, use of argon alone does not require gas mixtures.

As discussed, the use of ever-present argon ions provides a convenient check of the validity of calibrations that are currently in use. The argon ions may also be used as a recalibration. The use of argon with the plateau check and cross-calibration check avoids the need to regularly perform a full calibration. For example, previously if the instrument had not been calibrated for some time or the instrument appeared to be out of calibration the only option would be to perform a full calibration routine. This would require a user to provide a specific calibration solution to the instrument, hence requiring user interaction to input the solution to the instrument. It may also require selection of the correct calibration solution materials and for the user to instruct the instrument to commence the calibration routine. The calibration routine of the instrument itself might take 10 minutes. In some cases the calibration might not have been required such as if there is no change in calibration factors. With the plateau check and cross-calibration check of the present invention these checks can be performed quickly and regularly without taking up significant user or instrument time, and a recalibration would only need to be performed when the checks indicated it was necessary to do so. Hence, the checks also provide an indication if a calibration should be performed. Previously, measurements may have been performed on an instrument that is out of calibration, for example, if it was calibrated very recently but for some reason the performance of the detectors had drifted. This might result in erroneous measurement results.

Regarding the cross-calibration check it should be noted that different cross-calibration factors may apply to different ion masses. This is shown in FIG. 8. The abscissa shows the atomic mass of ions entering the detection device in atomic mass units (amu). The ordinate is the relative calibration factor between the two detectors. The triangles are measured data points. The line is a calculation of the cross-calibration values based on the measurements. As can be seen the cross-calibration factor is three to four, or even five, orders of magnitude. For example, at an atomic mass of 100, the calibration factor is 100×10³. These cross-calibration values have largely been determined based on ion species in one or more given samples. In the prior art a preferred range of amu for generating a cross-calibration is 100-150 amu. It can be seen that for low mass ³⁶Ar and ³⁸Ar argon ions (circled) the average detection efficiency is higher than that of heavier ions (because a lower cross-calibration factor is required). Hence, a calibration sample may still be required for a full instrument calibration but argons ions can be conveniently used for the plateau and cross-calibration checks.

For the cross calibration check the cross-calibration factor for one (or more) non-analyte or majority ions, such as argon ions, is measured and stored. A re-adjustment of the detector voltage(s), for example the voltage on the analogue detector, is made to bring the cross-calibration factor equal to the previously measured full calibration value, which may act as a target in setting the cross-calibration factor. When the detector voltage has been adjusted such that the cross-calibration factor meets the target, the cross-calibration factor for the non-analyte ions is effectively unchanged. Then it can be assumed that there are no changes required for the values for other ions and the original values for other ions can continue to be used unchanged. Alternatively, instead of readjusting the detector voltage the previously measured cross-calibration factors may be scaled across the range of amu. That is, they may be scaled according to the percentage that the measured cross calibration factor for the argon ions deviates from the value that it had after the last full calibration using a calibration solution containing multiple elements across the range of amu.

We have discussed that the plateau and cross-calibration checks may indicate that a recalibration is required. For example, a failure of the plateau check may indicate that the working point of the counting mode detector is no longer valid. In such a case the instrument may automatically start an on-the-fly recalibration of the working point and perform cross calibration based on the argon ion signals. In a further alternative, following a subsequent cross-calibration check using argon ions, if the cross-calibration or working point check suggest the calibration or working point is no longer valid, then the instrument may alert the user, such as by a notification or alarm, to input a calibration to the instrument and initiate a calibration routine, assuming the preferred way is that the calibration data should be renewed, instead of being estimated based on the response of the Ar-ions.

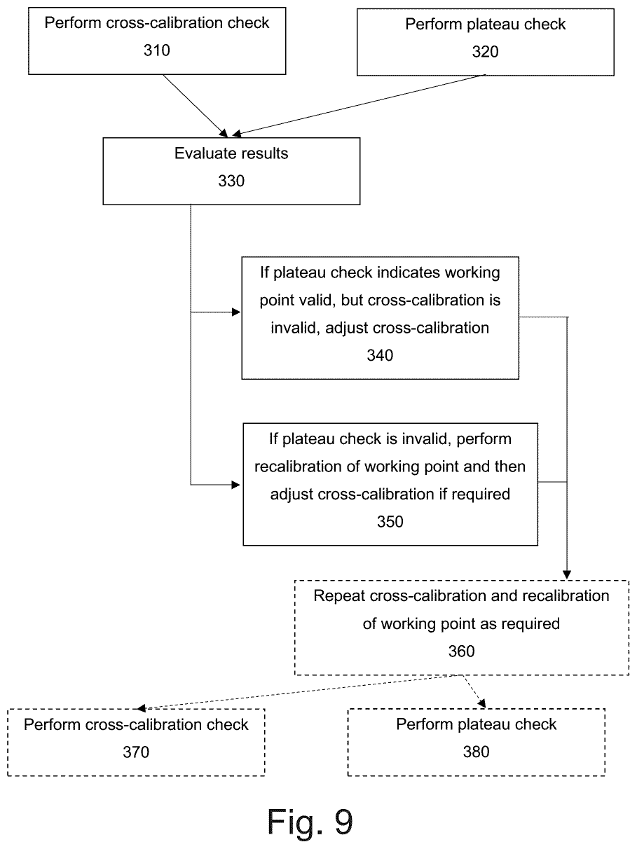

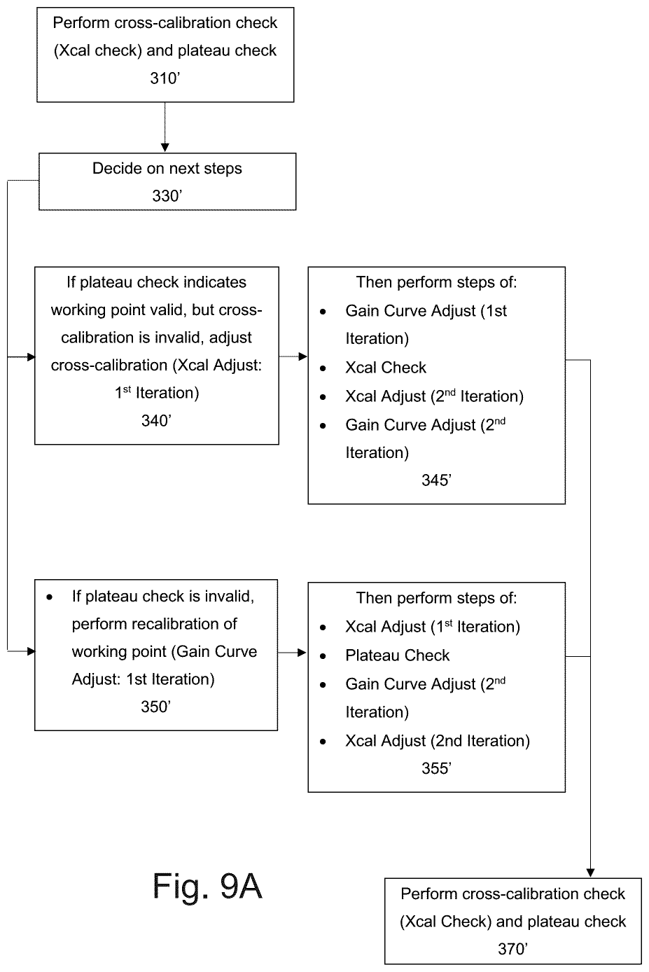

In some instances a recalibration of the working point may be required, whereas in others a recalibration of the cross-calibration may be needed. Often, if the working point is changed the cross-calibration will also need changing. FIG. 9 is a flow chart showing a calibration check and recalibration process method. FIG. 9A shows an alternative flow chart providing more detail of a specific embodiment of the method, such as when the working point is outside the range of variation in working points initially tested. We will start by describing FIG. 9. The method starts by performing the cross-calibration check 310 and plateau check 320 as described herein. These are usually performed together or in any order. At step 330 the results are evaluated to determine action to take. If the results of the cross-calibration check and the plateau check are within their respective target ranges such as 2%, 3% or 5%, no action is required. Step 340 indicates that if the cross-calibration only is out of the target range, then the cross-calibration is adjusted. We will describe below a process of cross-calibration. Step 350 indicates that if the plateau check is out of the target range, then a gain curve or working point calibration is performed followed by cross-calibration adjustment. Optionally, and not shown in FIG. 9, if the cross-calibration check is out of the target range by a wide margin, such as by 15% or more, then here also a gain or working point calibration may be performed followed by cross-calibration adjustment. At step 360 it is determined if any of the cross-calibration or working recalibration steps need to be repeated. This is best done by performing the already described plateau and cross-calibration checks on the resulting one full iteration of recalibrations, for example, if it has been difficult to get both the cross-calibration and the plateau checks into the target range. In such a case the range of adjustment for the calibrations may need to be increased. This step is optional since the cross-calibration and working points may have been correctly achieved at 340 and 350. Lastly, the cross-calibration check 370 and plateau check 380 may be performed again as final validation of the recalibrations.

As mentioned above, FIG. 9A provides more detail regarding the flow chart of FIG. 9, and in particular regarding the step 360 which is split out as new steps 345′ and 355′. Similarly to FIG. 9, the method may start with performing a cross-calibration check (Xcal check) and a plateau check, which are indicated in step 310′. We have indicated in relation to FIG. 9 that these checks may be performed together and, hence, are indicated in a single step in FIG. 9A. The next step in FIG. 9A is to evaluate the results and decide on the next steps to take, as indicated at step 330′. Similarly to FIG. 9, the next step is determined based on whether the working point and/or cross-calibration is determined to be invalid. If the working point is valid but the cross-calibration is invalid, then as indicated at step 340′ the cross-calibration is adjusted. As discussed below, because adjusting the cross-calibration may result in a different working point of the counting and/or analogue mode detectors, further steps may be required to be performed to set the detectors to correct operating points. These steps are indicated in FIG. 9A at 345′ and comprise:
performing an adjustment of the working point (Gain Curve Adjust), followed by
performing a cross-calibration check (Xcal check) and, if required,
performing a cross-calibration adjustment (Xcal Adjust) followed by
performing a further adjustment of the working point (Gain Curve Adjust, 2^{nd} Iteration).
   This is an iterative approach to bring the working point and cross-calibration to more appropriate operating points. A final check of the operating point is performed at step 370′ where the cross-calibration and plateau check are performed.

FIG. 9A also shows steps to be taken if the plateau check at 310′ determines the working point is not valid. In such a case the method moves to step 350′ and an adjustment of the working point is performed (Gain Curve Adjust: 1^{st} Iteration). This step is followed by the steps set out at 355′ of:
performing a cross-calibration adjustment (Xcal Adjust, 1^{st} Iteration) followed by
performing a check of the working point (Plateau check) and then, if needed,
performing an adjustment of the working point (Gain Curve Adjust: 2nd Iteration), followed by
performing a cross-calibration adjustment (Xcal Adjust: 2nd Iteration).
   Again, a final check of the operating point is performed at step 370′ where the cross-calibration and plateau check are performed.

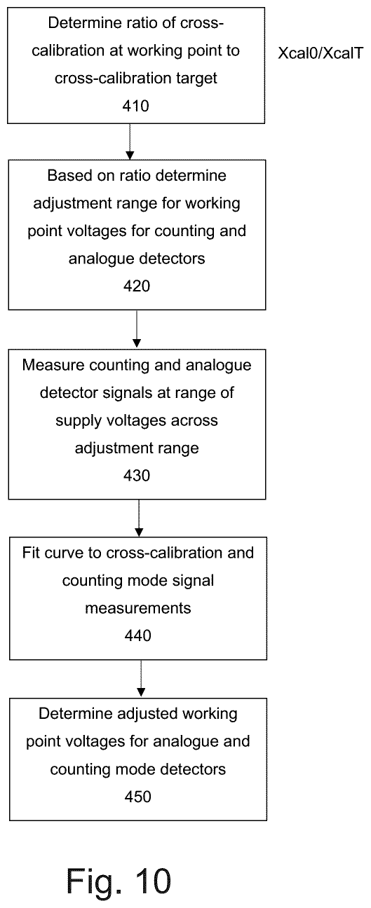

FIG. 10 is a flow chart showing a method of adjusting the cross-calibration (for example, Xcal Adjust) between the counting mode detector and the analogue detector. This method may be used when a cross-calibration adjustment is required such as at step 340 of FIG. 9 or step 340′ of FIG. 9A. Having previously measured the signals of the detectors at the working point, such as at step 210, the cross-calibration factor Xcal0 at the working point is determined and divided by the target cross-calibration factor XcalT to determine the ratio of the two. The ratio or relative difference between the two is an indication of how far away from a target cross-calibration the working point is and hence the amount of adjustment that is required. The target for a given system may be determined based on the dynamic range that is to be covered by the detection system. The target value is used to extend the dynamic range, for example by orders of 2, 4 or 6. Large spans of cross-calibration ranges, such as from 35 000 to 200 000 may be used, for example for extending the range by about one order of magnitude up to 6 orders.

In one example, if the ratio Xcal0/XcalT is in the range between 0.5 to 2.0, then the working point voltage for the analogue detector may be adjusted by 1.25% and the counting mode detector by 2.5%. Such adjustment steps will depend on the specific system that is to be calibrated. The direction of adjustment will be so as to increase the voltage between the analogue and counting mode detectors if the ratio is less than one (Xcal0 is less than XcalT), or decrease the voltage between the analogue and counting mode detectors if the ratio is greater than one (Xcal0 is greater than XcalT). For larger ratios the adjustment range may be larger and the number of measurements needed may be greater. The working point voltages are adjusted to cover the range in a series of steps at 420. Measurements are taken at the respective points, as indicated at 430. A polynomial is then fitted to specify the relationship between the counting mode supply voltages and the cross-calibration factor, as set out at step 440. For larger adjustment ranges and more measurement points higher order polynomials may be used. Based on the determined polynomial the predicted adjusted working point voltages for the analogue and counting mode detectors is determined.

Table 2 which follows shows some example ranges of adjustment respectively for the supply voltages for the analogue detector and counting mode detector, denoted by ΔUa and ΔUc respectively. The table also shows the number of measurement points and the order of the polynomial that may be fitted to the data to predict the adjusted working point voltages and cross-calibration factor.

TABLE 2

| Xcal0/XcalT | ΔUa | ΔUc | No. of points | Poly. Order |
|---|---|---|---|---|
| <1 | −1.25% | +2.5% | 3 | 2 |
| >1 | +1.25% | −2.5% | 3 | 2 |
| <0.5 | −2.5% | −5% | 4 | 2 |
| >2 | +2.5% | +5% | 4 | 2 |
| <0.25 | −5% | +10% | 5 | 3 |
| >4 | +5% | −10% | 5 | 3 |

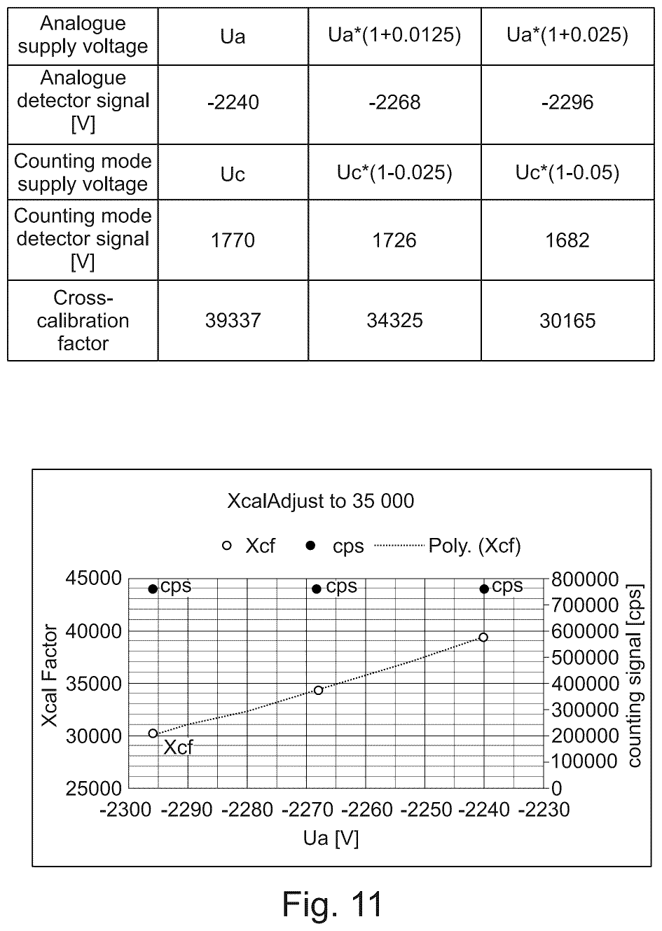

FIG. 11 shows a table and graph of data relating to an example of applying the method of FIG. 10 to a cross-calibration adjustment when Xcal0/XcalT >1. As can be seen in the table at the top of FIG. 11 the analogue supply voltage is adjusted to increase by a maximum of 2.5% and the counting mode supply voltage is adjusted to decrease by a maximum of 5%. As well as at the working point voltages and the maximum adjusted voltages, a third measurement is taken in between these at +1.25% increase in analogue voltage and −2.5% decrease in counting mode voltage. As can be seen in the table of FIG. 11 the counting mode and analogue mode detector voltages are adjusted together such that the measurement points may be described as:
(Ua, Uc), (Ua+1.25%, Uc−2.5%), (Ua+2.5%, Uc−5%)
   The adjustment values in FIG. 11 correspond to the examples of table 2. Each adjustment step is by ΔUa, ΔUc. Hence, for Xcal0/XcalT>1, the first adjusted values in the table of FIG. 11 are an increase of +1.25% in Ua and a decrease of 2.5% in Uc, as shown in the third column of the table in FIG. 1.

FIG. 11 also shows a graph of the data collected in the table of FIG. 11. The cross-calibration factor is plotted on the vertical axis against the analogue mode detector supply voltage, Ua, on the horizontal axis. A second order polynomial or other curve is fitted to the three datapoints. The target cross-calibration factor is 35,000. The polynomial is used to calculate the value of analogue mode detector supply voltage, Ua, at the target cross-calibration factor. In this case the supply voltage at the target is determined to be −2265 V. The plotting of the data points on a graph is helpful for visualizing the results but is not necessary. The polynomial or curve fitting can be done without requiring a graph. After the analogue mode detector supply voltage at the target has been determined, the counting mode detector supply voltage is determined by interpolation and/or scaling between the nearest points. In the example of FIG. 11 the counting mode supply voltage is determined to be 1730 V. The actual cross-calibration may be checked by measuring the signal values at the new working point voltages for the two detectors. The check is used to confirm that the cross-calibration value is in the acceptable range of the target.

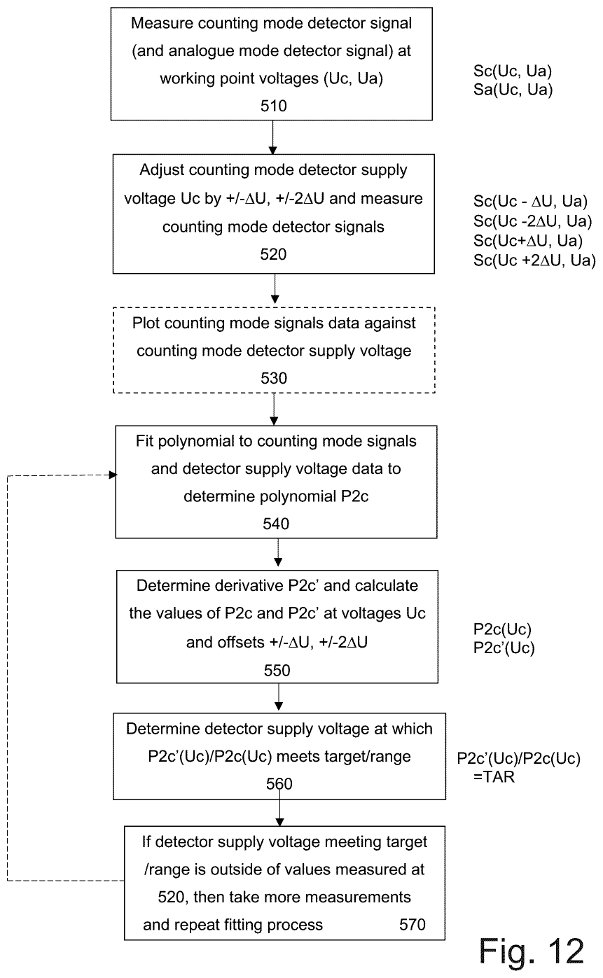

FIG. 12 is a flow chart showing a method of adjusting the working point voltages such as if the plateau check was failed. At step 510 the signals Sa, Sc, at the counting mode detector and the analogue mode detector are measured at their working point voltages. These values may have already been determined as part of the plateau check. As step 520 the supply voltage of the counting mode detector is adjusted and the signals at the counting mode detector are measured. At step 520 it is shown that the counting mode supply voltage is stepped by +/−ΔU, +/−2ΔU. ΔU may be 10% of the counting mode detector supply voltage at the current working point. Hence, the adjusted values are used to determine how the signal varies with supply voltage. Step 520 shows that the signal at four adjusted voltages may be measured. Some of these, such as +/−ΔU may have already been measured and therefore not need to be measured again, but in this example at least the +/−2ΔU signals will need to be measured. In some embodiments more or less measurements at adjusted voltages may be used. For example, signals measured only at +/−ΔU may be used or more may be used such as at +/−ΔU, +/−2ΔU and +/−3ΔU.

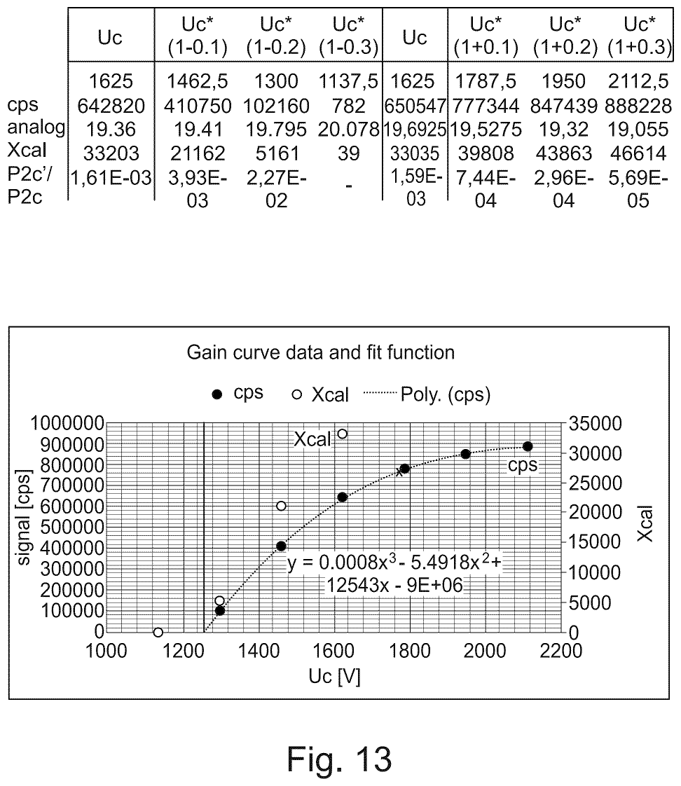

FIG. 13 has a table of data collected at Uc and +/−ΔU, +/−2ΔU and +/−3ΔU. Here ΔU is 10%. The initial working point voltage of the counting detector is set to 1625 V. The signals on the counting mode detector and the analogue mode detector are measured. The measured values are indicated respectively by cps (counts per second) and analogue in the table. The supply voltage of the counting mode detector is increased by 10, 20 and 30% and signals measured. The supply voltage of the analogue detector is not changed (during the plateau measurement). Next the supply voltage for the counting mode detector is returned to the initial working point voltage and the signal remeasured, then the supply voltage of the counting mode detector is decreased by 10, 20 and 30% and signals measured. The values of these measurements are shown in the table of FIG. 13.

Returning to FIG. 12, at step 530 the counting mode signals are plotted on a graph against the counting mode detector supply voltage. FIG. 13 includes a graph of the data in the table for that Figure. A curve such as a polynomial curve is fitted to the data, as also indicated at step 540. The polynomial is labelled P2c in FIG. 12. Here a third order polynomial is used. The table of FIG. 13 also includes values for cross-calibration calculated from the counting and analogue data. Data points at which the cross-calibration factor is low are not included in the fitting of the curve to the data. As can be seen, at the counting detector supply voltage that is decreased by 30% the cross-calibration factor has a value of 39 as compared to values in the 1000s and 10000s for the other measurements. Such a low value indicates that the detectors are operating on a low part of the gain curve and not near the high-gain plateau region. Datapoints that have a cross-calibration factor below a certain threshold may be excluded from the curve fitting. For example, the threshold for exclusion may be that the cross-calibration factor is less than 10% of the cross-calibration factor at the initial working point or of the target value.

The polynomial determined for the data points of this example is shown on the graph of FIG. 13. A derivative of the curve may be determined such that the gradient of the curve may be determined at any point along the curve. Step 550 of FIG. 12 indicates determining the derivative P2c′ of the curve P2c and calculating the value of the curve and derivative at the initial working point voltage Uc and offset voltages Uc+/−ΔU and Uc+/−2ΔU. At step 560 the ratio P2c′(Uc)/P2c (Uc) at the working point is determined and assessed to determine if it is within a target range. As shown in the table of FIG. 13 the values of this ratio at working point and offsets is indicated. For the example data of FIG. 13, a target range of between 8×10⁻⁴ and 9×10⁻⁴ is used. The target ratio represents an increase of the signal with 1 V higher detector voltage at (Uc−Ua), as we will describe further below. For the data of FIG. 13, this target range is between the counting mode detector supply voltages of the initial working point voltage Uc (1625 V) and the offset value Uc+10% (1787.5 V). By setting a nominal value in the target range such as in the middle of the target range (for example, 8.5×10⁻⁴) the ratio P2c′(Uc)/P2c (Uc) can be solved to determine a value of the counting mode supply voltage that satisfies the target. For the data of FIG. 13, the new working point voltage is determined as 1770V which is indicated by “x” on the graph.

The target range of between 8×10⁻⁴ and 9×10⁻⁴ used here is approximately equivalent to a condition that there is a >9% drop in signal per 100V shift towards lower voltages from the working point and a <8% increase in signal per 100V shift towards higher voltages from the working point. This is about equivalent to the conditions shown in FIG. 4, which shows a curve having a 13% drop in signal per 100V shift towards lower voltages from the working point and a 4% increase in signal per 100V shift towards higher voltages from the working point.

As indicated at step 570 in FIG. 12, if the target condition cannot be found in the range of Uc and offset values used, then the range of measurements will need to be extended in the appropriate direction and additional data points measured, for example, Uc+40%, Uc+50%.

As indicated in FIG. 9 at step 350 (and in FIG. 9A at 355′), after the working point has been adjusted the cross-calibration may need further adjustment. The cross-calibration can first be checked using the cross-calibration check described in relation to FIG. 7. If adjustment of the cross-calibration is required, then the cross-calibration can be adjusted such as by using the method described in relation to FIGS. 10 and 11. In many cases no cross-calibration adjustment will be required. In a small number of cases a subsequent cross-calibration adjustment may significantly affect the working point voltage of the counting mode detector and the method of FIG. 12 may need to be repeated. As indicated in FIG. 9, the recalibrations can be confirmed by final plateau and cross-calibration checks. The instrument is then ready for performing analyses.

As discussed above, the calibration checks and recalibrations may be performed using argon ions that are used to flow a sample through the analyser, and they can be performed in the background without user input.

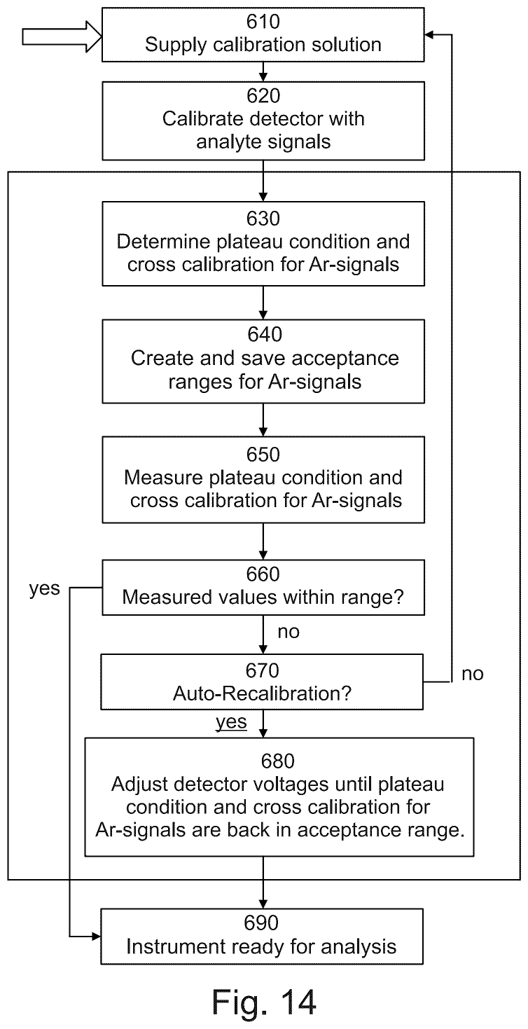

FIG. 14 is alternative flow chart to that of FIG. 9 and links to an optional user prompted calibration of the analyser with a calibration solution. The method of FIG. 14 may commence at step 610. The first steps of the method relate to setting the calibration of the device by a user using a calibration solution. The detector is calibrated at 620 with signals from analytes in the calibration solution. At steps 630 and 640, based on the calibration, values obtained with non-analyte argon ions are used to determine acceptance ranges for the plateau condition and cross calibration check. These values are then stored for use later. After operation of the instrument for a period of time, at step 650, signals may be measured using the non-analyte argon ions and the plateau check and cross-calibration checks may be performed. At step 660 the measured values are compared to the acceptance range. If the measured values are within the range, the instrument is ready for analysis, as indicated at step 690. At step 670, if the measured values are outside of the acceptance range then either a new user calibration is performed, by returning to step 610, or a calibration is performed using the methods set out herein using non-analyte argon ions. The latter may be considered an on-the fly calibration. The argon ion based calibration is at step 680 and comprises adjusting the detector supply voltages until the results of the plateau check and cross-calibration check are back in the acceptance range determined at step 640. After the results of the checks are back in the acceptance range, the instrument is ready for analysis, as indicated at step 690. This procedure can be combined with a continuous calibration control and analyte based cross-calibration. This can be determined from the measured signals from unknown samples or standard samples while a regular analysis task is performed.

The person skilled in the art will readily appreciate that various modifications and alterations may be made to the above described methods and apparatus. The modifications may be made without departing from the scope of the appended claims. For example, different values and ranges may be used, the order of steps of methods may be changed and aspects of different embodiments may be combined.

1. A method of checking calibration of a dual-mode secondary electron multiplier (SEM) detector of a mass spectrometer using non-analyte ions, the method comprising:
setting a counting mode detector of the dual-mode SEM detector to a calibrated working point by providing a working point supply voltage to the counting mode detector;
recording, using the counting mode detector, a first count signal related to a number of non-analyte ions incident at the SEM detector;
offsetting the working point of the counting mode detector by adjusting the supply voltage to the counting mode detector;
recording, using the counting mode detector, second count signals at respective two or more offset working point voltages related to the number of non-analyte ions incident at the SEM detector;
fitting a non-linear function to the first and second recorded count signals and values corresponding to the working point voltages; and
determining that the calibration is valid if a rate of change of the non-linear function at the calibrated working point is within an acceptance range.

2. The method of claim 1, wherein offsetting the working point of the counting mode detector by adjusting the supply voltage to the counting mode detector comprises offsetting the working point to a first offset working point at a voltage higher than the working point voltage and offsetting the working point to a second offset working point at a voltage lower than the working point voltage; and
wherein recording the second count signals at the respective two or more offset working point voltages comprises recording an upper second count signal at the first offset working point voltage and recording a lower second count signal at a second offset working point voltage.

3. The method of claim 1, wherein the acceptance range is an acceptance range normalized with respect to the count signal at the calibrated working point.

4. The method of claim 3, wherein the normalised acceptance range is a less than 15% rate of change in the non-linear function at the working point.

5. The method of claim 1, wherein the non-linear function is a second order polynomial.

6. The method of claim 1, wherein if the rate of change of the non-linear function at the calibrated working point is not within the acceptance range, estimating based on the non-linear function the supply voltage at which the rate of change of the non-linear function will be within the acceptance range, and adjusting the working point to the estimated supply voltage.

7. The method of claim 6, further comprising recording an updated first count signal at the counting mode detector with the working point changed to the estimated supply voltage, re-fitting a non-linear function to data comprising the first count signal, second recorded count signals and the updated first count signal at the estimated supply voltage, and determining if the rate of change of the non-linear function at the estimated supply voltage is within the acceptance range.

8. The method of claim 6, wherein estimating based on the non-linear function the supply voltage at which the count signal will be within the acceptance range comprises estimating the supply voltage at which the rate of change of the non-linear function is at a target value in the acceptance range.

9. The method of claim 1, wherein if the rate of change of the non-linear function at the calibrated working point is not within the acceptance range, providing an alert to a user requesting the user perform a recalibration of the counting mode detector.

10. The method of claim 1, wherein if it is determined that the calibration is not valid, performing a recalibration of the counting mode detector.

11. The method of claim 10, wherein the recalibration comprises:
offsetting the working point of the counting mode detector by adjusting the supply voltage to the counting mode detector to one or more second offset voltages;
recording, using the counting mode detector, third count signals at respective one or more second offset working point voltages related to the incidence of non-analyte ions at the SEM detector;
fitting a second non-linear function to the first, second and third recorded count signals and values corresponding to the working point voltages; and
estimating based on the second non-linear function the supply voltage at which the rate of change of the second non-linear function will be within a second acceptance range, and adjusting the working point to the estimated supply voltage.

12. The method of claim 11, wherein the second non-linear function is a third order polynomial.

13. The method of claim 11, wherein the second acceptance range is a less than 5%, less than 9%, less than 10% or less than 15% rate of change in the non-linear function at the working point.

14. The method of claim 1, further comprising recording an analogue signal at an analogue mode detector of the dual-mode SEM detector;
calculating a cross-calibration factor between the analogue mode detector and the counting mode detector based on the first count signal and the analogue signal at working points of the counting mode detector and analogue mode detector; and
checking if the cross-calibration factor is within a window or a target calibration factor.

15. The method of claim 14, wherein if it is determined that the cross-calibration is not valid, performing a cross-calibration correction between the counting mode detector to an analogue mode detector.

16. The method of claim 15, wherein the cross-calibration correction comprises:
recording, using the analogue mode detector at the working point supply voltage, a first analogue mode signal related to the number of non-analyte ions incident at the SEM detector;
recording, using the counting mode detector, a first cross-calibration counting mode signal related to the number of non-analyte ions incident at the SEM detector;
offsetting the working point of the analogue mode detector and the counting mode detector by adjusting the supply voltages to the analogue mode detector and the counting mode detector;
recording, using the analogue mode detector and counting mode detector at the adjusted supply voltages, a second analogue mode signal and a second cross-calibration counting mode signal, related to the number of non-analyte ions;
repeating the step of offsetting and recording a further second analogue mode signal and a further second cross-calibration counting mode signal;
determining cross-calibration factors for the first, second and further second analogue mode signals and counting mode signals; and
fitting a third non-linear function to the first, second and further second analogue mode signals and values corresponding to the working point voltages of the analogue detector; and
estimating based on the third non-linear function the analogue detector supply voltage at which the cross-calibration factor is in an acceptance range or meets a target;
based on the estimated analogue detector supply voltage at which the cross-calibration factor is in an acceptance range or meets a target, estimating a counting mode detector supply voltage for the acceptance range or target; and
adjusting the working point voltages of the analogue mode detector and counting mode detector to the estimated supply voltages.

17. The method of claim 1, wherein the non-analyte ions are argon ions, noble gas ions or nitrogen ions.

18. The method of claim 1, wherein the steps of any preceding claim are performed using non-analyte ions without a calibration solution.

19. The method of claim 1, wherein the steps are performed:
prior to running an analysis on a sample; and/or
in the background without alerting a user.

20. The method of claim 19, wherein the method is performed at regular intervals in the background without alerting a user.

21. A method of checking calibration of a dual-mode secondary electron multiplier (SEM) detector of a mass spectrometer, the method comprising:
obtaining a first count signal from a counting mode detector at a working point voltage, the first count signal related to a quantity of non-analyte ions incident at the SEM detector;
obtaining second count signals related to the non-analyte ions at two or more offset working point voltages of the counting mode detector;
fitting a non-linear function to the first and second count signals and values corresponding to the working point voltages; and
determining that the calibration is valid if a rate of change of the non-linear curve at the calibrated working point is within an acceptance range.

22. A computer-readable medium storing instructions, which when executed by a processor, causes the processor to carry out a method according to claim 21.

23. A mass spectrometer comprising a dual-mode secondary electron multiplier (SEM) detector configured to perform the method of claim 1.
